(19) United States
(12) Patent Application Publication
(10) Pub. No.: US 2025/0367858 A1
(43) Pub. Date: Dec. 4, 2025

(54) PROCESS FOR RECYCLING USED PLASTICS BASED ON POLYPROPYLENE USING A LIGHT HYDROCARBON SOLVENT

(71) Applicant: IFP ENERGIES NOUVELLES, Rueil-Malmaison (FR)

(72) Inventors: Damien LEINEKUGEL LE COCQ, Rueil-Malmaison cedex (FR); Wilfried WEISS, Rueil-Malmaison cedex (FR); Emilie BORDES, Rueil-Malmaison cedex (FR); Alexandra BERLIOZ-BARBIER, Rueil-Malmaison cedex (FR)

(73) Assignee: IFP ENERGIES NOUVELLES, (omitted)

(21) Appl. No.: 18/875,076

(22) PCT Filed: Jun. 5, 2023
(86) PCT No.: PCT/EP2023/065002

§ 371 Date: Dec. 13, 2024

(30) Foreign Application Priority Data
Jun. 14, 2022 (FR) FR2205771

(51) Int. Cl. B29B 17/02; B29K 23/00; C08J 11/08

(52) U.S. Cl. CPC B29B 17/02; C08J 11/08; B29B 2017/0289; B29B 2017/0293; B29K 2023/12; C08J 2323/10

(57) ABSTRACT

The present invention relates to a process for purifying a plastic feedstock comprising polypropylene, involving:
a) dissolving the plastic feedstock in a dissolution solvent comprising a hydrocarbon-based compound having a boiling point of between −15° C. and 100° C., at a dissolution temperature of between 150° C. and 250° C., a dissolution pressure of between 1.0 and 18.0 MPa absolute, to obtain a crude polymer solution;
b) purifying the crude polymer solution, comprising:
   b1) separation of the insoluble matter;
   b2) washing, with a dense solution;
   b3) extraction, with an extraction solvent; and/or
   b4) adsorption of the impurities; and then
c) solvent-polymer separation, using a supercritical separation section, at a temperature of between 160 and 300° C. and a pressure of between 2.7 and 10.0 MPa absolute, followed by at least one solvent recovery section, to obtain purified polypropylene.

### TECHNICAL FIELD

The present Invention relates to a process for recycling used plastics predominantly comprising polypropylene (or PP) in order to obtain a stream of purified polypropylene which can be economically upgraded, for example in the manufacture of new plastic objects. More particularly, the present invention relates to a process for purifying a plastic feedstock, in particular obtained from plastic waste, comprising polymers and in particular polypropylene, said process comprising the dissolution of the polymers in a light hydrocarbon solvent, in particular based on alkane(s) with a boiling point of between −15° C. and 100° C., at least one step of purifying the polymer solution obtained, in order to at least partly remove the impurities, in particular the additives conventionally used in plastic-based materials, and an optimized step of separating the purified polypropylene and the solvent, so as to be able to reuse the recovered purified polypropylene and thus economically upgrade the plastic feedstock.

### PRIOR ART

Plastics obtained from collection and sorting channels can be upgraded according to various channels.

“Mechanical” recycling makes it possible to partly reuse certain waste either directly in new objects or by mixing the streams of mechanically sorted plastic waste with streams of virgin polymers. This type of economic upgrading is limited since mechanical sorting makes it possible to improve the purity of a stream of a given type of polymer but it generally does not make it possible to sufficiently remove the impurities that are at least partly trapped in the polymer matrix, for instance the additives, such as the fillers, colorants, pigments and metals.

“Chemical” recycling is directed towards at least partly reforming monomers via a sequence of steps that is generally complex. For example, plastic waste may undergo a pyrolysis step and the pyrolysis oil recovered, generally after purification, may be at least partly converted, for example, into olefins by steam cracking. These olefins may then be polymerized. This type of sequence may be suitable for feedstocks that have undergone little sorting or for sorting centre refuse but it generally requires a large consumption of energy in particular due to the high temperature treatments.

Another route for recycling plastic waste consists in at least partly dissolving the plastics, in particular thermoplastics, for the purpose of purifying them by removing the polymers of the feedstock other than that or those targeted and/or the impurities, for example the additives such as the fillers, colorants, pigments and metals.

Several studies thus present various methods for treating plastic waste by dissolution and purification. US 2017/002110 describes a particular method for purifying a polymer feedstock, in particular obtained from plastic waste, by dissolving the polymer in a solvent, under particular temperature and pressure conditions, followed by placing the polymer solution obtained in contact with a solid.

WO 2018/114047 proposes, for its part, a method for dissolving a plastic in a solvent at a dissolution temperature close to the boiling point of the solvent. However, the process of WO 2018/114047 does not make it possible to efficiently process the impurities other than the polymers.

US 2018/0208736 proposes a treatment process by liquefaction of thermoplastics in a solvent followed by separating out the insoluble matter and/or the gases. The process of US 2018/0208736 does not make it possible to efficiently process the impurities that are soluble in the solvent.

The present invention aims to overcome these drawbacks and to participate in the recycling of plastics. More particularly, it aims to propose an effective, simple and economically viable process for treating a plastic feedstock based on polypropylene, in particular obtained from plastic waste, in order to at least partly eliminate the impurities which it contains, in particular at least partly the additives which it contains and which are conventionally added to plastics, so as to be able to economically upgrade said plastic feedstock and more particularly the plastic waste. The present invention seeks in fact to efficiently separate the impurities from the polymers, and in particular from the polypropylene, contained in the used plastics and to recover the purified polypropylene, in order to be able to use it, for example, as polymer base in the manufacture of new plastic objects, in particular instead of virgin resin.

### SUMMARY OF THE INVENTION

The invention relates to a process for purifying a plastic feedstock which comprises polypropylene, said process comprising:
a) a dissolution step involving placing the plastic feedstock in contact with a dissolution solvent, comprising at least one hydrocarbon-based compound having a boiling point of between −15 and 100° C., at a dissolution temperature of between 150° C. and 250° C. and a dissolution pressure of between 1.0 and 18.0 MPa absolute, to obtain at least one crude polymer solution;
b) a step of purifying the crude polymer solution to obtain a purified polymer solution, comprising:
   b1) a sub-step of separating out the insoluble matter; and/or
   b2) a sub-step of washing, by contact with a dense solution; and/or
   b3) a sub-step of extraction, by contact with an extraction solvent; and/or
   b4) a sub-step of adsorption of the impurities by contact with an adsorbent; and then
c) a solvent-polymer separation step, using at least one supercritical separation section operated at a temperature of between 160 and 300° C. and at a pressure (Psupercritical) of between 2.7 and 10.0 MPa absolute, followed by at least one solvent recovery section, to obtain at least one purified polypropylene fraction.

The advantage of the process of the invention is to propose a process for efficiently treating a plastic feedstock based on polypropylene, and in particular of plastic waste based on polypropylene, especially obtained from collection and sorting channels, so as to recover the polypropylene which it contains to be able to recycle it into any type of application. The process according to the invention makes it possible to obtain a stream of purified polypropylene advantageously comprising contents of impurities, in particular of additives, and of solvent, in particular of dissolution solvent, which are negligible or at least sufficiently low for the stream of purified polypropylene to be able to be introduced into any type of plastics formulation in place of virgin polypropylene resin. For example, the stream of purified polypropylene obtained at the end of the process according to the invention advantageously comprises less than 5% by weight of impurities, very advantageously less than 1% by weight of impurities and very advantageously less than 5% by weight of solvent (in particular dissolution solvent), preferably less than 1% by weight of solvent, preferably less than 0.1% by weight of solvent.

The process according to the invention thus proposes a simple scheme corresponding to a sequence of operations, which makes it possible to remove at least a portion of the impurities from the plastic waste based on polypropylene, in particular at least some of the additives, and to recover purified polypropylene, advantageously comprising little or even no solvent, so as to be able to economically upgrade the plastic waste by recycling the purified polypropylene. Advantageously, depending on the conditions used in the steps of the process, the additives present in the plastic feedstock may be soluble or insoluble in the solvent used throughout the process according to the invention, allowing efficient purification and separation of the polymers.

In addition, the process according to the invention proposes a sequence of operations performed under optimum operating conditions, in particular in terms of temperature and pressure, to efficiently separate the impurities and solvents from the polypropylene, but reasonable operating conditions, thus limiting the energy consumption of the process and, consequently, making said process economically advantageous.

The invention also has the advantage of participating in the recycling of plastics and in conserving the fossil resources, by enabling the economic upgrading of plastic waste. Specifically, it allows the purification of plastic waste for the purpose of obtaining purified polypropylene fractions, with a reduced content of impurities, in particular decolourized and deodourized polypropylene fractions, which may be reused for forming new plastic objects. The purified polypropylene fractions obtained may thus be used directly in formulations as a mixture with additives, for example colorants, pigments or other polymers, in place of or as a mixture with virgin resins, for the purpose of obtaining plastic products having aesthetic, mechanical or rheological working properties, which facilitate their reuse and their economic upgrading.

The present invention also enables the polypropylene to be separated efficiently, and advantageously at lower cost, from the solvent used (in particular the dissolution solvent), while at the same time limiting the thermal degradation of the polypropylene. Thus, the solvent used for treating the plastic feedstock, in particular the dissolution solvent, is at least partly recovered, and can be recycled into one of the steps of the process, thus avoiding excessive solvent consumption, whence the ecological and economic advantage of the process.

Thus, the present invention aims to purify a plastic feedstock, in particular plastic waste, to obtain purified polypropylene, so as to be able to use it in any application in particular in replacement for virgin resins.

More particularly, the present invention aims to propose a process comprising a dissolution step followed by at least one purification step and then an optimized solvent/polymer separation, to obtain a stream of purified polypropylene.

### DESCRIPTION OF THE EMBODIMENTS

According to the present invention, the expressions “comprised between . . . and . . . ” and “between . . . and . . . ” are equivalent and mean that the limit values of the interval are included in the described range of values. If such is not the case and if the limit values are not included in the described range, such a clarification will be given by the present invention.

For the purposes of the present invention, the various ranges of parameters for a given step, such as the pressure ranges and the temperature ranges, may be used alone or in combination. For example, within the meaning of the present invention, a range of preferred pressure values can be combined with a range of more preferred temperature values.

In the text hereinbelow, particular embodiments of the invention may be described. They may be implemented separately or combined together without limitation of combinations when this is technically feasible.

According to the present invention, the pressures are absolute pressures and are given in MPa absolute (or MPa abs).

The terms “upstream” and “downstream” should be understood as a function of the general flow of the fluid(s) or stream(s) under consideration in the process.

The term “additives” is a term conventionally used in the field of polymers and in particular in the field of polymer formulations. The additives introduced into the polymer formulations may be, for example, plasticizers, fillers (which are organic or mineral solid compounds used for modifying the physical, thermal, mechanical and/or electrical properties of polymer materials or for reducing the cost price thereof), reinforcing agents, colorants, pigments, hardeners, flame retardants, combustion retardants, stabilizers, antioxidants, UV absorbers, antistatic agents, etc.

The additives correspond to at least a portion of the impurities of the plastic feedstock to be treated and which the process according to the invention makes it possible to at least partly remove. Other types of impurities may be use-related impurities, for instance metal impurities, papers/cardboard, biomass, polymers other than the targeted polypropylene (for instance polyethylene), etc.

Thus, according to the invention, the impurities which the process according to the invention makes it possible to at least partly remove comprise the additives conventionally used in polymer formulations and generally use-related impurities derived from the life cycle of the plastic objects and materials, and/or derived from the waste collection and sorting circuit. Said impurities may be impurities of metallic, organic or mineral type; they may be packaging residues, food residues or compostable residues (biomass). These use-related impurities may also comprise glass, wood, cardboard, paper, aluminium, iron, metals, tyres, rubber, silicones, rigid polymers, thermoplastic polymers other than polypropylene, thermosetting polymers, household, chemical or cosmetic products, spent oils and water.

According to the invention, a polymer solution is a solution comprising the dissolution solvent and at least the targeted polypropylene, which is dissolved (i.e. in particular solvated and dispersed) in said dissolution solvent, the dissolved polypropylene being initially present in the feedstock. The polymer solution may also comprise soluble impurities (that are dissolved in the dissolution solvent) and/or insoluble impurities (that are suspended in the polymer solution). As a function of the steps of the process according to the invention that have been undertaken, said polymer solution may thus comprise impurities in the form of insoluble particles which are advantageously in suspension in said polymer solution, soluble impurities dissolved in the dissolution solvent, and/or optionally another liquid phase that is immiscible with said polymer solution.

The critical temperature and critical pressure of a solvent, in particular of the dissolution solvent, are specific to said solvent and depend on the chemical nature of the solvent under consideration. For a pure substance, the critical temperature and the critical pressure of a pure substance are, respectively, the temperature and the pressure of the critical point of said pure substance. As is well known to those skilled in the art, at and above the critical point, the pure substance under consideration is in supercritical form or in the supercritical state; it may then be referred to as a supercritical fluid.

The invention relates to a process for purifying a plastic feedstock, preferably composed of plastic waste, and comprising polypropylene, said process comprising, and preferably consisting of:
a) a dissolution step comprising contacting the plastic feedstock with a dissolution solvent comprising at least one hydrocarbon-based compound which is advantageously aliphatic and preferably paraffinic, with a boiling point of between −15 and 100° C., preferably between 8 and 100° C., preferentially between 25 and 69° C., preferably between 25 and 61° C. and very preferably between 25 and 40° C., at a dissolution temperature of between 150° C. and 250° C., preferably between 160 and 225° C., preferentially between 165° C. and 210° C., and preferably between 170° C. and 195° C., and a dissolution pressure of between 1.0 and 18.0 MPa abs., preferably between 1.0 and 12.0 MPa abs., preferentially between 3.0 and 11.0 MPa abs., preferably between 5.0 and 11.0 MPa abs. and very preferably between 6.0 and 10.0 MPa abs., to obtain at least one crude polymer solution; and then
b) a step of purifying the crude polymer solution, comprising at least one of the following sub-steps:
   b1) a sub-step of separating out the insoluble matter to obtain at least one clarified polymer solution and preferably an insoluble fraction; and/or
   b2) a sub-step of washing, by contact with a dense solution, to obtain at least one washed polymer solution and preferably a washing effluent; and/or
   b3) a sub-step of extraction, by contact with an extraction solvent, to obtain at least one extracted polymer solution and preferably a used solvent; and/or
   b4) a sub-step of adsorption of the impurities by contact with an adsorbent, to obtain at least one refined polymer solution;
the purification step making it possible to obtain a purified polymer solution which advantageously corresponds to a clarified and/or washed and/or extracted and/or refined polymer solution; and then
c) a solvent-polymer separation step using at least one supercritical separation section operated at a temperature of between 160 and 300° C., preferably between 190 and 250° C., preferentially between 200 and 230° C., and at a pressure (Psupercritical) of between 2.7 and 10.0 MPa abs., preferably between 3.0 and 6.0 MPa abs., preferentially between 3.0 and 5.0 MPa abs. and preferably between 3.0 and 4.0 MPa abs., followed by at least one solvent recovery section, in particular operated at a temperature of between 160 and 300° C. and a pressure between Psupercritical and 0.000005 MPa (i.e. 5 Pa), preferentially between 2.7 MPa and 0.000005 MPa, and in particular between 1.0 MPa and 0.000005 MPa, to obtain at least one fraction of purified polypropylene and advantageously a solvent fraction.

### The Feedstock

The feedstock of the process according to the invention, known as the plastic feedstock, comprises plastics which themselves more particularly comprise polypropylene. Preferably, the plastic feedstock comprises between 50% and 100% by weight and preferably between 70% and 100% by weight of plastics.

The plastics included in the feedstock of the process according to the invention are based on polypropylene and are generally production waste and/or waste plastic objects at the end of their life, in particular household plastic waste, plastic waste from the construction industry, plastic waste from cars or from any type of transport or electrical and electronic equipment waste. Preferably, the plastic waste is derived from collection and sorting channels. In general, plastics or plastic materials comprise polymers that are mixed with additives, for the purpose of constituting, after forming into shape, various materials and objects (injection-moulded parts, tubes, films, fibres, fabrics, mastics, coatings, etc.). The additives used in plastics may be organic compounds or inorganic compounds. They are, for example, fillers, colorants, pigments, plasticizers, property modifiers, combustion retardants, etc.

Preferably, the feedstock of the process according to the invention comprises at least 80% by weight, preferably at least 85% by weight and preferably at least 90% by weight of polypropylene, relative to the total weight of the plastic feedstock. The process according to the invention is thus most particularly directed towards purifying and recovering the polypropylene contained in the feedstock to be able to reuse it in various applications.

The plastic feedstock may also comprise impurities, for instance polymers, in particular thermoplastics, other than polypropylene, additives advantageously used for formulating the plastic material and also generally use-related impurities originating from the life cycle of the materials and plastic objects, and/or originating from the waste collection and sorting circuit. The plastic feedstock of the process according to the invention may comprise up to 20% by weight of impurities, preferentially up to 15% by weight of impurities, preferably up to 10% by weight of impurities. The plastic feedstock may comprise, for example, at least 5% by weight of impurities.

The plastic feedstock may advantageously be pretreated prior to the process so as to at least remove all or some of the “coarse” impurities, i.e. impurities in the form of particles greater than or equal to 10 mm, preferably greater than or equal to 5 mm, or even greater than or equal to 1 mm in size, for example impurities such as wood, paper, biomass, iron, aluminium, glass, etc., and to put it into form, generally into the form of divided solids (or particles) so as to facilitate the treatment in the process. This pretreatment may comprise a milling step, a step of washing at atmospheric pressure and/or a drying step. This pretreatment may be performed at a different site, for example in a waste collection and sorting centre, or at the same site where the treatment process according to the invention is performed. Preferably, this pretreatment makes it possible to reduce the content of impurities to less than 20% by weight, preferably less than 15% by weight, preferably less than 10% by weight, the percentages being given relative to the weight of the plastic feedstock treated by means of the process according to the invention. At the end of the pretreatment, the feedstock is generally stored in the form of divided solids, for example in the form of ground material or powder, so as to facilitate the handling and transportation into the process.

### Dissolution Step a)

According to the invention, the process comprises a dissolution step a) in which the plastic feedstock is placed in contact with a dissolution solvent, to obtain at least one, preferably one, crude polymer solution. Specifically, this step advantageously enables the dissolution of at least a portion and preferably of all of the polypropylene of the plastic feedstock.

The term “dissolution” should be understood as meaning any phenomenon leading to the production of at least one polymer solution, in particular a polypropylene solution, i.e. a liquid comprising polymers, in particular polypropylene, dissolved in a solvent, more particularly in the dissolution solvent. A person skilled in the art is fully aware of the phenomena involved in the dissolution of polymers and which comprise at least mixing, dispersion, homogenization, solvation and disentangling of the polymer chains, and more particularly of the polypropylene chains.

During and at the end of the dissolution step a), the pressure and temperature conditions make it possible to maintain the dissolution solvent at least partly and preferably totally in liquid form, so as to optimize the dissolution of the targeted polypropylene.

The nature of the dissolution solvent advantageously allows the use of operating conditions, and in particular temperature and pressure conditions, in particular pressure conditions, which are reasonable so as to ensure firstly, in the dissolution step a) but also advantageously in the purification step b), the maintenance of the dissolution solvent at least partly and preferably totally in the liquid phase, thus allowing optimum dissolution of the targeted polypropylene and advantageously efficient purification of the polymer solution, and secondly, in the solvent-polymer separation step c), the passage to the supercritical state of at least a portion of said dissolution solvent, to allow the demixing and thus the separation of at least a portion of the dissolution solvent, and optionally the at least partial evaporation of the residual dissolution solvent, which thus makes it possible to achieve a very low solvent content in the purified polypropylene recovered at the end of the process (advantageously a content of less than 5% by weight of solvent, preferably less than 1% by weight of solvent, preferably less than 0.1% by weight of solvent relative to the total weight of the purified polypropylene fraction). Indeed, a solvent composed of very light alkanes with a boiling point below −15° C., for instance propane, which could be advantageous in particular for its relatively mild critical conditions (temperature and pressure), would require the use of a high pressure to keep the dissolution solvent at least partly, and preferably totally, in liquid form throughout the dissolution steps a) and purification steps b), which would entail significant costs, in particular investment costs. Conversely, the use of a heavy solvent, such as alkanes with a boiling point above 100° C., would require very stringent operating conditions in step c) in order to reach the critical conditions of said heavy solvent and to be able to obtain said solvent at least partly in the supercritical state.

Advantageously, the dissolution solvent comprises, preferably consists of, at least one hydrocarbon-based compound which is advantageously aliphatic and preferably paraffinic (i.e. saturated), preferably at least one alkane, with a boiling temperature between −15 and 100° C., preferably between 8 and 100° C., preferably between 25 and 69° C., preferably between 25 and 61° C. and very preferably between 25 and 40° C. Preferably, the dissolution solvent comprises predominantly, preferably to at least 80% by weight, preferentially at least 95% by weight, preferably 98% by weight, of a hydrocarbon-based compound, which is advantageously aliphatic, preferably paraffinic (or alkane) (100% being the maximum, the percentages being expressed relative to the total weight of the dissolution solvent) with a boiling point of between −15 and 100° C., preferably between 8 and 100° C., preferentially between 25 and 69° C., preferably between 25 and 61° C. and very preferably between 25 and 40° C. Very advantageously, the hydrocarbon-based compound, which is advantageously aliphatic, preferably paraffinic, which forms the predominant amount of the dissolution solvent, has a critical temperature (temperature at the critical point of said pure hydrocarbon-based compound) of between 130 and 285° C., preferably between 158 and 285° C., preferentially between 185 and 245° C., preferably between 185 and 230° C. and very preferably between 185 and 200° C. Very particularly, the paraffinic hydrocarbon-based compound, which forms the predominant amount of the dissolution solvent, has a critical pressure of between 2.5 and 5.0 MPa, preferably between 2.7 and 4.6 MPa, preferentially between 3.0 and 3.8 MPa, and preferably between 3.0 and 3.5 MPa. According to a preferred embodiment, the dissolution solvent predominantly comprises, preferably to at least 80% by weight, preferentially at least 95% by weight, preferably 98% by weight, an aliphatic paraffinic hydrocarbon-based compound, which is preferably linear or branched, with a boiling point of between −15 and 100° C., preferably between 8 and 100° C., preferentially between 25 and 69° C., preferably between 25 and 61° C. and very preferably between 25 and 40° C., and containing between 4 and 7 carbon atoms (i.e. C4-C7), preferably 5, 6 or 7 carbon atoms (C5, C6 or C7, respectively), preferably containing 5 or 6 carbon atoms (C5 or C6) and very preferentially containing 5 carbon atoms (C5).

Advantageously, the dissolution step a) is performed at a dissolution temperature of between 150° C. and 250° C., preferentially between 160° C. and 225° C., very preferentially between 165° C. and 210° C. and preferably between 170° C. and 195° C., and a dissolution pressure of between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute. More particularly, the temperature and pressure may change throughout step a), from the conditions of introduction of the plastic feedstock and/or dissolution solvent, for example from ambient conditions, i.e. a temperature of between 10 and 30° C. and atmospheric pressure (0.1 MPa), until the dissolution conditions are reached, i.e. the dissolution temperature, in particular between 150° C. and 250° C., preferentially between 160 and 225° C., very preferentially between 165° C. and 210° C. and preferably between 170 and 195° C., and the dissolution pressure, in particular between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute. Very advantageously, at the end of the dissolution step a), the stream of dissolved polymers, in particular the polymer solution, is at the dissolution temperature and at the dissolution pressure.

Limiting the temperature in step a) to a temperature of less than or equal to 250° C., preferably less than or equal to 225° C., preferentially less than or equal to 210° C. or even 195° C., makes it possible to avoid or to limit the thermal degradation of the polymers, in particular of the polypropylene, but also to limit the energy requirement of the process, thus contributing towards limiting the operating costs and the carbon footprint of the process. Preferably, the dissolution temperature is greater than or equal to the melting point of the polypropylene, so as to promote its dissolution.

In parallel, the dissolution pressure is advantageously greater than the saturating vapour pressure of the dissolution solvent, at the dissolution temperature, so that the dissolution solvent is at least partly, and preferably totally, in liquid form at the dissolution temperature, so as to optimize the dissolution of the targeted polypropylene.

Very advantageously, the dissolution temperature and pressure conditions reached in step a) are adjusted so that the mixture (dissolution solvent+polypropylene) is homogeneous and very preferably single-phase, said mixture possibly comprising insoluble impurities suspended in said mixture. Preferably, the weight ratio (feedstock/solvent) between the plastic feedstock and the dissolution solvent (or the ratio between the mass flow rate of the plastic feedstock and the mass flow rate of the dissolution solvent, at the inlet of the dissolution step a)) is between 0.01 and 2.0, preferably between 0.05 and 1.0, preferably between 0.10 and 0.8.

Advantageously, the dissolution step a) is performed for a residence time of between 1 and 600 minutes, preferably between 2 and 300 minutes, preferably between 5 and 180 minutes. The residence time is understood as being the residence time at the dissolution temperature and at the dissolution pressure, i.e. the time of implementation of the plastic feedstock with the dissolution solvent at the dissolution temperature and at the dissolution pressure, in step a).

Advantageously, the dissolution solvent comprises, and preferably consists of, a supply of fresh solvent and/or a stream of recycled solvent obtained from a subsequent step of the process, preferably obtained from the solvent-polymer separation step c).

Contacting the dissolution solvent with the plastic feedstock to at least partly and preferably totally dissolve the polypropylene of the plastic feedstock in the dissolution solvent may be performed in a line and/or an item of equipment and/or between two items of equipment. Thus, step a) advantageously involves at least one item of dissolution equipment, and optionally at least one feedstock preparation device, a mixing device and/or a transportation device. These items of equipment and/or devices may be, for example, a static mixer, an extruder, a pump, a reactor, a co-current or counter-current column, or in a combination of lines and of equipment. Devices for transportation in particular of fluids, such as liquids or solids, are well known to those skilled in the art. In a non-limiting manner, the transportation devices may comprise a pump, an extruder, a vibrating tube, an endless screw or a valve. The items of equipment and/or devices may also comprise or be combined with heating systems (for example an oven, an exchanger, a tracing, etc.) to achieve the conditions required for dissolution. The dissolution step a) may be performed continuously, in batch mode or in fed-batch mode.

The dissolution step a) is at least fed with the plastic feedstock, in particular in the form of one or more streams of plastic feedstock, and with the dissolution solvent, in particular in the form of one or more streams of dissolution solvent, advantageously by means of one or more transportation devices. The stream(s) of plastic feedstock may be different from the stream(s) of dissolution solvent. A portion or all of the plastic feedstock may also feed step a) as a mixture with a portion or all of the dissolution solvent, the remainder of the solvent and/or of the feedstock, where appropriate, possibly feeding step a) separately.

During contacting the plastic feedstock with the dissolution solvent, the dissolution solvent is advantageously at least partly, and preferably totally, in liquid form, whereas the plastic feedstock, which comprises polypropylene, may be in solid or liquid form optionally comprising solid particles in suspension. The plastic feedstock may also optionally be injected into the dissolution equipment, as a mixture with the dissolution solvent, in the form of a suspension in the dissolution solvent, the preparation and injection of the suspension possibly being continuous or batchwise.

According to a particular embodiment of the invention, step a) may use an extruder and optionally at least one other item of dissolution equipment. In this case, the plastic feedstock feeds, optionally with at least a fraction of the dissolution solvent, the extruder such that, at the extruder outlet, at least a portion and preferably all of the targeted polypropylene, included in the feedstock are in molten form (or in at least partly dissolved form). The plastic feedstock, optionally mixed with at least a fraction of the dissolution solvent, is then injected into an item of dissolution equipment, for example a reactor, at least partly in molten form (or partly dissolved form). The plastic feedstock, at least partly in molten form (and/or partly dissolved form) leaving the extruder, may also be pumped by means of a pump dedicated to viscous fluids, often known as a melt pump or a gear pump. The plastic feedstock at least partly in molten form (or partly dissolved form) may, at the extruder outlet, also be filtered using a filtration device, optionally in addition to the melt pump, for the purpose of removing the coarsest particles; generally, the mesh size of this filter is between 10 microns and 1 mm, preferably between 20 and 200 microns.

Preferably, step a) includes an extruder into which the dissolution solvent is injected, advantageously at several points, so as to promote shear and thus intimate mixing between the dissolution solvent and the plastic feedstock, which contributes towards dissolving the polypropylene.

Optionally, the treatment process may include an intermediate adsorption step a′), situated during the dissolution step a) or directly downstream of the dissolution step a), and which comprises the introduction of an adsorbent, preferably such as alumina, silica, silica-alumina, active charcoal or bleaching earth, in the form of divided particles, into the crude polymer solution obtained at the end of step a) or optionally during the dissolution step a). The adsorbent may then be removed during the purification step b), for example during a sub-step b1) of separating out the insoluble matter and/or a washing sub-step b2). This optional step a′) of adsorption in the presence of an adsorbent in divided form makes it possible to optimize the purification of the polymer solution.

The crude polymer solution obtained at the end of the dissolution step a) comprises at least the dissolution solvent, the polypropylene that the present invention seeks to recover purified, dissolved in the dissolution solvent. In general, the crude polymer solution also comprises soluble impurities that are also dissolved in the dissolution solvent. The crude polymer solution may optionally also comprise insoluble impurities or compounds in suspension. The crude polymer solution obtained at the end of step a) may optionally also comprise polymers, other than the target polypropylene, for example in molten form.

At the end of the dissolution step which is performed under such operating conditions, in particular in terms of temperature and pressure, the polypropylene of the plastic feedstock is advantageously totally or partly dissolved in the dissolution solvent; the polypropylene solution obtained (i.e. the crude polymer solution) will be able to undergo the purification step b) and then the solvent-polymer separation step c), so as to recover the polypropylene from the plastic feedstock, in purified form, with very low contents of impurities and of residual solvent, which are compatible with any type of subsequent application. Thus, the process according to the invention allows the recovery of the polypropylene from plastic waste in an optimal manner and under entirely reasonable operating conditions (in particular a well-bounded, i.e. limited, dissolution pressure), and thus with a controlled energy consumption and consequently a limited cost.

### Step b) of Purification of the Polymer Solution

The purification process according to the invention comprises a step of purifying the crude polymer solution obtained from step a). This purification step b) comprises at least one of the sub-steps b1), b2), b3) and b4) described below:
b1) a sub-step of separating out the insoluble matter,
b2) a sub-step of washing, by contact with a dense solution,
b3) a sub-step of extraction, by contact with an extraction solvent,
b4) a sub-step of adsorption of the impurities by contact with an adsorbent.

The various sub-steps b1), b2), b3) and b4) which can be performed in the purification step b) may be operated continuously, in batch mode or in fed-batch mode.

Preferably, the purification step b) comprises at least one sub-step b1) of separating out the insoluble matter. The purification step b) preferably comprises several (i.e. at least two) sub-steps chosen from sub-steps b1), b2), b3) and b4), in series, and preferably at least one sub-step b1) of separating out the insoluble matter and, for example, one adsorption sub-step b4), very advantageously in that order. The combination of at least two sub-steps chosen from b1), b2), b3) and b4) advantageously allows optimum purification of the polymer solution.

The polymer solution obtained at the end of step b) is a purified polymer solution and comprises polypropylene dissolved in at least the dissolution solvent. This purified polymer solution may correspond to a clarified polymer solution obtained from a sub-step b1) of separating out the insoluble matter, a washed polymer solution obtained from a washing sub-step b2), an extracted polymer solution obtained from an extraction sub-step b3) or a refined polymer solution obtained from a sub-step b4) of adsorbing the impurities.

### Sub-Step b1) of Separating Out the Insoluble Matter

The purification process may comprise a sub-step b1) of separating out the insoluble matter by solid-liquid separation, to advantageously obtain at least one polymer solution which is clarified (in other words at least partially, preferably entirely, free of insoluble matter that the crude polymer solution comprises) and preferably an insoluble fraction. The insoluble fraction advantageously comprises at least a portion, and preferably all, of the insoluble impurities, in particular in suspension in the crude polymer solution obtained from step a).

Sub-step b1) of separating out the insoluble matter thus makes it possible to remove at least a portion, and preferably all, of the particles of insoluble compounds in the dissolution solvent, present in suspension in the crude polymer solution obtained from step a) or from an optional step a′). The insoluble compounds (or impurities) removed during the sub-step b1) of separating out the insoluble matter are, for example, pigments, mineral compounds, packaging residues (glass, wood, cardboard, paper, aluminium) and insoluble polymers.

When it is performed, this separation sub-step b1) advantageously makes it possible, besides removing at least a portion of the insoluble impurities, to limit the operating problems, in particular such as clogging and/or erosion, of the process steps downstream of such a sub-step b1), while at the same time contributing towards the purification of the plastic feedstock.

Sub-step b1) of separating out the insoluble matter is advantageously performed at a temperature preferably between 150° C. and 250° C., preferentially between 160° C. and 225° C., very preferentially between 165° C. and 210° C. and preferably between 170° C. and 195° C., and a pressure of between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute. Very advantageously, sub-step b1) of separating out the insoluble matter is performed at the temperature and pressure conditions at the outlet of the dissolution step a), i.e. at the dissolution temperature and dissolution pressure as defined above.

When it is incorporated into the process, sub-step b1) of separating out the insoluble matter is preferably fed with the crude polymer solution obtained from step a) or obtained from an optional intermediate adsorption step a′). According to another embodiment, sub-step b1) may be fed with a washed polymer solution obtained from a washing sub-step b2).

Advantageously, sub-step b1) includes at least one section for solid-liquid separation (or solid-liquid-liquid separation, in particular in the case where the effluent obtained from the dissolution step also comprises, in addition to the polymer solution and the solid impurities, impurities and/or polymers which are different in nature from the targeted polypropylene, in liquid or barely soluble or insoluble form). The solid-liquid separation section comprises at least one item of solid-liquid separation equipment, for example a separating vessel, a decanter, a centrifugal decanter, a centrifuge, a filter, a sand filter, a tangential filter in particular using a membrane and/or a deep filter, an eddy current separator, an electrostatic separator, a triboelectric separator, preferably a decanter, a filter, a sand filter and/or an electrostatic separator. Advantageously, a self-cleaning filter may be used, the cleaning or unclogging allowing the removal of the insoluble matter being performed using a solvent stream. Preferably, sub-step b1) includes at least one decantation section advantageously comprising at least one decanter and/or at least one filtration section. During sub-step b1), filtration adjuvants (for example diatomaceous earths or sand) may optionally be added prior to the decantation and/or filtration.

The removal of the insoluble fraction may be facilitated by equipment for transporting and/or removing the traces of solvent that may be present in the insoluble fraction, for example a conveyor, a vibrating tube, an endless screw, an extruder or a stripper. Sub-step b1) may thus include equipment for transporting and/or removing traces of solvent to remove the insoluble fraction. Advantageously, at least a portion of the solvent recovered in sub-step b1) is recycled into the process.

According to a particular embodiment, sub-step b1) of separating out the insoluble matter includes at least two, and generally less than five, items of solid-liquid separation equipment in series and/or in parallel. The presence of at least two items of solid-liquid separation equipment in series makes it possible to improve the removal of the insoluble matter, whereas the presence of equipment in parallel makes it possible to manage the maintenance of said equipment and/or of the unclogging operations.

Certain insoluble compounds, in particular certain pigments and mineral fillers, conventionally added during the formulation of polymers, may be in the form of particles less than 1 μm in size. This is the case, for example, for titanium dioxide, calcium carbonate and carbon black. According to a particular embodiment of sub-step b1), said sub-step b1) of separating out the insoluble matter advantageously includes an electrostatic separator, which makes it possible to efficiently remove at least a portion of the insoluble particles less than 1 μm in size. According to another particular embodiment of sub-step b1), sub-step b1) of separating out the insoluble matter includes a sand filter, to remove the particles of different sizes and in particular the particles less than 1 μm in size. According to yet another particular embodiment, sub-step b1) of separating out the insoluble matter involves a tangential filter in particular using a membrane and/or a deep filter, optionally in the presence of filtration adjuvants such, for instance diatomaceous earth.

Depending on the nature of the feedstock, the polymer solution which feeds sub-step b1), preferably the crude polymer solution, may optionally also comprise a second liquid phase, for example consisting of molten polymers, these polymers being different in nature from that of the polypropylene. According to another particular embodiment, sub-step b1) advantageously includes a solid-liquid-liquid separation section, including equipment for separating out two liquid phases and one solid phase, preferably by means of at least one two-phase or three-phase separator.

### Washing Sub-Step b2)

The purification process may optionally comprise a sub-step b2) of washing with a dense solution, to advantageously obtain at least one washed polymer solution and preferably a washing effluent. The washed polymer solution obtained at the end of sub-step b2) advantageously comprises the polypropylene that the present invention seeks to recover purified, dissolved in the dissolution solvent. Optionally, the washed polymer solution may further comprise residual impurities which are in particular soluble in the dissolution solvent and/or optionally traces of the washing solvent (i.e. traces of dense solution) if sub-step b2) is performed.

The washing sub-step b2) may be integrated upstream or downstream, preferably downstream, of a sub-step b1) of separating out the insoluble matter, when these two sub-steps are integrated into the purification step b).

When it is integrated into the process, the washing sub-step b2) is fed with a dense solution and with the crude polymer solution obtained from step a) or obtained from an optional intermediate adsorption step a′), or else with the clarified polymer solution obtained from b1). The polymer solution which feeds the washing sub-step b2), in particular the crude or clarified polymer solution, may comprise impurities in the form of insoluble compounds in suspension and/or in the form of dissolved compounds. These compounds in suspension or dissolved compounds may be partly or totally removed during the washing sub-step b2) by dissolution or precipitation and/or by entrainment in the dense solution. Thus, when it is performed, this sub-step b2) contributes towards the treatment of the plastic feedstock and more particularly towards the purification of the polymer solution.

The washing sub-step b2) advantageously involves placing the polymer solution, which feeds sub-step b2), i.e. the crude or clarified polymer solution, in contact with a dense solution. Advantageously, the dense solution has a higher density than the polymer solution (i.e. the mixture comprising at least the targeted polypropylene and the dissolution solvent in which the targeted polypropylene is dissolved). In particular, the dense solution has a density preferably greater than or equal to 0.85, preferably greater than or equal to 0.9, preferentially greater than or equal to 1.0, and preferably less than or equal to 1.5. The dense solution may be an aqueous solution, which preferably comprises at least 50% by weight of water, preferably at least 75% by weight of water, very preferably at least 90% by weight of water. The pH of the aqueous solution may be adjusted using an acid or a base so as to promote the dissolution of certain compounds. The dense solution may also optionally be a solution comprising, preferably consisting of, an organic solvent with a density advantageously greater than or equal to 0.85, preferably greater than or equal to 0.9, preferentially greater than or equal to 1.0, and in which the polypropylene of the plastic feedstock remains insoluble under the temperature and pressure conditions of sub-step b2), for example an organic solvent chosen from sulfolane or N-methylpyrrolidone (NMP), optionally as a mixture with water. Very preferably, the dense solution is an aqueous solution which preferably comprises at least 50% by weight of water, preferably at least 75% by weight of water, very preferably at least 90% by weight of water.

The washing sub-step b2) is advantageously performed at a temperature preferably between 150° C. and 250° C., preferentially between 160° C. and 225° C., very preferentially between 165° C. and 210° C. and preferably between 170° C. and 195° C., and at a pressure of between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute. Very advantageously, the washing sub-step b2) is performed at the dissolution temperature and the dissolution pressure.

In the washing sub-step b2), when it is incorporated into the process, the mass ratio (dense solution/polymer solution) between the mass flow rate of the dense solution and the mass flow rate of the polymer solution which feeds sub-step b2) is advantageously between 0.05 and 20.0, preferably between 0.1 and 10.0 and preferably between 0.5 and 3.0. The placing in contact between the polymer solution and the dense solution may be performed at several points in the equipment used, i.e. via several injections of the polymer solution and/or of the dense solution at different points along the equipment; it is then the sum of the streams injected that is taken into account in the calculation of the mass ratio (dense solution/polymer solution).

Sub-step b2) may be performed in one or more items of washing equipment enabling the placing in contact with the dense solution and/or with separation equipment making it possible to recover at least one washing effluent and one washed polymer solution. This equipment is well known, for example stirred reactors, static mixers, decanting mixers, two-phase or three-phase separating vessels, co-current or counter-current washing columns, plate columns, stirred columns, packed columns, pulsed columns, etc., each type of equipment possibly comprising one or more items of equipment used alone or in combination with equipment of another type.

According to a preferred embodiment, the washing sub-step b2) is performed in a counter-current washing column in which the dense solution is injected, preferably into the upper half, preferably the upper third, of the column that is preferably the closest to the top of the column, on the one hand, and the crude or clarified polymer solution is injected, preferably into the lower half, preferably the lower third, of the column that is preferably the closest to the bottom of the column, on the other hand. According to this embodiment, it is possible to recover at least one washed polymer solution and advantageously a washing effluent.

According to a very particular embodiment, the streams at the washing column inlet and/or outlet may be divided and injected at several injection points along the column and/or withdrawn at several withdrawal points along the column.

According to another embodiment, the washing sub-step b2) is performed in a mixer-decanter comprising a stirred mixing zone, to place the dense solution and the crude or clarified polymer solution in contact, and a decantation zone, making it possible to recover a washed polymer solution and advantageously a washing effluent.

At the end of the washing sub-step b2), the washing effluent advantageously obtained in particular comprises compounds dissolved in the dense solution and/or insoluble compounds entrained in the washing effluent. The washing effluent may be retreated in a washing effluent treatment section, on the one hand to at least partly separate out the dissolved and/or entrained compounds and optionally to purify the washing effluent, to obtain a purified dense solution, and on the other hand to at least partly recycle a portion of the purified dense solution. This washing effluent treatment section may include one or more items of equipment that are well known for solid-liquid separation, for example a separating vessel, a decanter, a centrifugal decanter, a centrifuge or a filter. The washing effluent may also be sent outside the process, for example to a used water treatment station when the dense solution is an aqueous solution.

### Extraction Sub-Step b3)

Step b) of the process according to the invention may comprise a sub-step b3) of extraction by placing in contact with an extraction solvent, to obtain at least one extracted polymer solution and preferably a used solvent in particular charged with impurities. The extracted polymer solution obtained at the end of sub-step b3) advantageously comprises the polypropylene which the present invention seeks to recover purified, dissolved in the dissolution solvent. Optionally, the extracted polymer solution may further comprise residual impurities which are in particular soluble in the dissolution solvent and/or traces of dense solution and/or of the extraction solvent if sub-step(s) b2) and/or b3) is (are) performed.

When it is integrated into the process according to the invention, the extraction sub-step b3) is advantageously positioned between the dissolution step a) and the solvent-polymer separation step c), preferably downstream of a sub-step b1) of separating out the insoluble matter and possibly upstream or downstream of an adsorption sub-step b4) if the latter is also integrated into step b).

The extraction sub-step b3) is advantageously fed with an extraction solvent and with the polymer solution, in particular the crude polymer solution obtained from step a), the clarified polymer solution obtained from sub-step b1), the washed polymer solution obtained from sub-step b2) or the refined polymer solution obtained from an adsorption sub-step b4). Preferably, the extraction sub-step b3) is fed with an extraction solvent and with the clarified polymer solution obtained from sub-step b1), the washed polymer solution obtained from sub-step b2) or optionally with a refined polymer solution obtained from an adsorption sub-step b4). The polymer solution which feeds sub-step b3), preferably the clarified polymer solution, the washed polymer solution or the refined polymer solution, may thus optionally comprise, besides polypropylene, dissolved compounds or dissolved impurities. These dissolved compounds may be partly or totally removed during the extraction sub-step b3) by placing in contact with an extraction solvent. Very advantageously, the combination of an extraction sub-step b3) with a sub-step b1) of separating out the insoluble matter and optionally a washing sub-step b2) and/or an adsorption sub-step b4) allows improved purification of the polymer solution, making use of the affinity of the impurities both for the extraction solvent and possibly for the dense solution and/or an adsorbent.

When it is incorporated into the process according to the invention, the extraction sub-step b3) advantageously involves at least one extraction section, preferably between one and five extraction sections, very preferably one extraction section.

The mass ratio (extraction solvent/polymer solution) between the mass flow rate of the extraction solvent and the mass flow rate of the polymer solution which feeds sub-step b3), preferably the clarified polymer solution, the washed polymer solution or the refined polymer solution, is advantageously between 0.05 and 20.0, preferably between 0.1 and 10.0 and preferably between 0.2 and 5.0. The placing in contact between the polymer solution which feeds sub-step b3), preferably the clarified polymer solution, the washed polymer solution or the refined polymer solution, and the extraction solvent may be performed at several points in the extraction section, i.e. via several injections of the polymer solution and/or of the extraction solvent at different points along the extraction section; it is then the sum of the streams injected that is taken into account in the calculation of the mass ratio (extraction solvent/polymer solution).

The extraction solvent used in the extraction sub-step b3) advantageously comprises an organic solvent or a mixture of organic solvents. Preferably, the extraction solvent comprises, preferably consists of, at least one hydrocarbon-based compound which is advantageously aliphatic and preferably paraffinic, preferably at least one alkane, with a boiling point of between −15 and 100° C., preferably between 8 and 100° C., preferentially between 25 and 69° C., preferably between 25 and 61° C. and very preferably between 25 and 40° C. Preferably, the extraction solvent predominantly comprises, preferably to at least 80% by weight, preferentially at least 95% by weight, preferably 98% by weight, a preferably paraffinic aliphatic, hydrocarbon-based compound (or alkane) (100% being the maximum, the percentages being expressed relative to the total weight of the dissolution solvent) with a boiling point of between −15 and 100° C., preferably between 8 and 100° C., preferentially between 25 and 69° C., preferably between 25 and 61° C. and very preferably between 25 and 40° C. Very advantageously, the hydrocarbon-based compound, which is advantageously aliphatic, preferably paraffinic, which forms the majority of the extraction solvent, has a critical temperature (temperature at the critical point of said pure hydrocarbon-based compound) of between 130 and 285° C., preferably between 158 and 285° C., preferentially between 185 and 245° C., preferably between 185 and 230° C. and very preferably between 185 and 200° C. According to a preferred embodiment, the extraction solvent predominantly comprises, preferably, to at least 80% by weight, preferentially at least 95% by weight, preferably 98% by weight, an aliphatic paraffinic hydrocarbon-based compound, which is preferably linear or branched, with a boiling point of between −15 and 100° C., preferably between 8 and 100° C., preferentially between 25 and 69° C., preferably between 25 and 61° C. and very preferably between 25 and 40° C., and containing between 4 and 7 carbon atoms (C4-C7), preferably 5, 6 or 7 carbon atoms (C5, C6 or C7, respectively), preferentially containing 5 or 6 carbon atoms (C5 or C6) and very preferentially containing 5 carbon atoms (C5).

Very preferably, the extraction solvent used in b3) is the same solvent as the dissolution solvent used in step a), optionally in a different physical state (for example the extraction solvent in supercritical form relative to the dissolution solvent in liquid form), so as to facilitate the management of the solvents and in particular their purification and their recycling in particular into the dissolution step a) and optionally into the extraction sub-step b3). Another advantage of using identical dissolution and extraction solvents, in identical or different physical states, resides, in addition to facilitating the management of the solvents involved in the process according to the invention, in particular the recovery of the solvents, their treatment and their recycling into at least one of the steps of the process, in the limitation of the energy consumptions and of the costs generated in particular by the treatment and purification of the solvents.

The extraction section(s) of b3) may comprise one or more items of extraction equipment, enabling the placing in contact with the extraction solvent and/or with separation equipment for recovering at least one used solvent, in particular charged with impurities, and an extracted polymer solution. This equipment is well known, for instance stirred reactors, static mixers, decanting mixers, two-phase or three-phase separating vessels, co-current or counter-current washing columns, plate columns, stirred columns, packed columns, pulsed columns, etc., each type of equipment possibly comprising one or more items of equipment used alone or in combination with equipment of another type.

According to a preferred embodiment of b3), the extraction is performed in a counter-current extraction column where the extraction solvent is injected, on the one hand, and the polymer solution which feeds sub-step b3) is injected, on the other hand. According to this embodiment, it is possible to recover at least one extracted polymer solution, on the one hand, and a used solvent in particular charged with impurities, on the other hand. Preferably, the polymer solution which feeds b3), preferably the clarified, washed or refined polymer solution, is injected into the upper half, preferably the upper third, of the column that is the closest to the top of the counter-current extraction column, whereas the extraction solvent is injected into the lower half, preferably the lower third, of the column that is preferably the closest to the bottom of the counter-current extraction column.

The streams at the counter-current extraction column inlet and/or outlet may be divided at several injection points and/or withdrawal points along the column.

According to another embodiment of b3), the extraction is performed in a mixer-decanter which advantageously comprises, on the one hand, a stirred mixing zone for placing in contact the extraction solvent and the polymer solution which feeds sub-step b3), preferably the clarified, washed or refined polymer solution, and, on the other hand, a decantation zone making it possible to recover an extracted polymer solution, on the one hand, and a used solvent, on the other hand.

Advantageously, the extraction sub-step b3) is performed under temperature and pressure conditions that are different from the temperature and pressure conditions of the dissolution step a).

According to a preferred embodiment of b3), the extraction sub-step b3) involves a liquid/liquid extraction section. Preferably, the liquid/liquid extraction section is operated at between 150° C. and 250° C., preferentially between 160° C. and 225° C., very preferentially between 165° C. and 210° C. and preferably between 170° C. and 195° C., and at a pressure of between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute. In any case, in this embodiment, the temperature and pressure conditions are adjusted so that the extraction solvent is in liquid form, the dissolution solvent preferably also being in liquid form. Very advantageously, the liquid/liquid extraction, in particular when the extraction solvent is the same as the dissolution solvent, is performed under temperature and pressure conditions that are different from the dissolution conditions of step a), in particular at a temperature above the dissolution temperature and/or at a pressure below the dissolution pressure, so as thus to be in a two-phase zone of the corresponding polymer-solvent mixture diagram.

According to another preferred embodiment of b3), the extraction sub-step b3) includes a section for extraction under particular temperature and pressure conditions in which the extraction solvent is advantageously, at least partly, in supercritical form. Such an extraction may be referred to as supercritical extraction. In this embodiment, the extraction is performed by placing the polymer solution which feeds b3), preferably the clarified, washed or refined polymer solution, in contact with an extraction solvent, advantageously under temperature and pressure conditions which make it possible to obtain a supercritical phase predominantly (i.e. preferably at least 50% by weight, preferentially at least 70% by weight, preferably at least 90% by weight) composed of the extraction solvent. In other words, in this embodiment, the extraction is performed by placing the polymer solution which feeds b3), preferably the clarified, washed or refined polymer solution, in contact with an extraction solvent which is at least partly, preferably totally, in supercritical form. Such a supercritical extraction sub-step b3) advantageously allows efficient purification of the polymer solution, in particular due to the very high affinity of the organic impurities, for instance some of the additives, in particular certain colorants or plasticizers, for the supercritical phase. The use of an extraction solvent in supercritical form also makes it possible to create a substantial density difference between the supercritical phase and the polymer solution in liquid form, which facilitates the demixing and separation by decantation between the two phases, i.e. between the supercritical phase and the liquid phase, which consequently contributes towards effectiveness of the purification of the polymer solution.

In this other preferred embodiment, sub-step b3) uses an extraction solvent comprising predominantly, preferably to at least 80% by weight, preferentially at least 95% by weight, preferably 98% by weight, a preferably paraffinic aliphatic, hydrocarbon-based compound (or alkane) (100% being the maximum, the percentages being expressed relative to the total weight of the dissolution solvent) having a critical temperature preferably between 130 and 285° C., preferably between 158 and 285° C., preferentially between 185 and 245° C., very preferentially between 185 and 230° C. and preferably between 185 and 200° C. Very preferably, in such a supercritical extraction sub-step b3), the extraction solvent predominantly comprises, preferably to at least 80% by weight, preferentially at least 95% by weight, preferably 98% by weight, a paraffinic aliphatic hydrocarbon-based compound with a boiling point of between −15 and 100° C., preferably between 8 and 100° C., preferentially between 25 and 69° C., very preferentially between 25 and 61° C. and preferably between 25 and 40° C., and containing between 4 and 7 carbon atoms (i.e. C4-C7), preferably 5, 6 or 7 carbon atoms (C5, C6 or C7, respectively), preferentially containing 5 or 6 carbon atoms (C5 or C6) and very preferentially containing 5 carbon atoms (C5). Very particularly, the paraffinic aliphatic hydrocarbon-based compound which forms the majority of the extraction solvent has a critical pressure of between 2.5 and 5.0 MPa, preferably between 2.7 and 4.6 MPa, preferentially between 3.0 and 3.8 MPa, and preferably between 3.0 and 3.5 MPa.

Advantageously, the supercritical extraction sub-step b3) of this particular embodiment is performed at a temperature preferably between 160° C. and 300° C., preferentially between 190 and 250° C., preferably between 200° C. and 230° C., and at a pressure preferably between 2.7 and 10.0 MPa absolute, preferentially between 3.0 and 6.0 MPa absolute, preferably between 3.0 and 5.0 MPa absolute and very preferably between 3.0 and 4.0 MPa absolute. According to a very particular mode of this embodiment of sub-step b3), the pressure at which the supercritical extraction is performed is very advantageously between the critical pressure (CP (extraction solvent)) of the predominant paraffinic aliphatic hydrocarbon-based compound of the extraction solvent (i.e., preferably, the critical pressure of the predominant paraffinic aliphatic hydrocarbon-based compound with a boiling point of between −15 and 100° C., preferably between 8 and 100° C., preferentially between 25 and 69° C., very preferentially between 25 and 61° C. and preferably between 25 and 40° C., and containing between 4 and 7 carbon atoms, preferably 5, 6 or 7 carbon atoms, preferentially containing 5 or 6 carbon atoms and very preferentially containing 5 carbon atoms, as defined above) and a pressure equal to 3.0 MPa above the critical pressure of the predominant paraffinic aliphatic hydrocarbon-based compound of the extraction solvent (i.e.: CP (extraction solvent)+3.0 MPa), preferably between the critical pressure of the predominant paraffinic aliphatic hydrocarbon-based compound of the extraction solvent (CP (extraction solvent)) and a pressure equal to 1.5 MPa above the critical pressure of the predominant paraffinic aliphatic hydrocarbon-based compound of the extraction solvent (i.e.: CP (extraction solvent)+1.5 MPa), preferably between the critical pressure of the predominant paraffinic aliphatic hydrocarbon-based compound of the extraction solvent (CP (extraction solvent)) and a pressure equal to 0.5 MPa above the critical pressure of the predominant paraffinic aliphatic hydrocarbon-based compound of the extraction solvent (i.e.: equal to CP (extraction solvent)+0.5 MPa), the pressures being absolute pressures. In any case, in this embodiment, the temperature and pressure conditions are adjusted, in particular in an adjustment section implemented in the extraction sub-step b3) upstream of the extraction section, so that the extraction solvent is at least partly in the supercritical state in the extraction section, the adjustment of the temperature and pressure of the extraction solvent in said adjustment section being advantageously performed by means known to a person skilled in the art (using, for example, a pump and/or valve and/or turbine and/or exchanger and/or oven).

In a very preferred embodiment of b3), the extraction sub-step b3) involves supercritical extraction and the extraction solvent is the same as the dissolution solvent (or comprises the same predominant compound as the dissolution solvent and possibly impurities), apart from the fact that the extraction solvent is at least partly in the supercritical phase.

Advantageously, at the end of the extraction sub-step b3), the used solvent obtained is in particular charged with impurities. It may be retreated in an organic treatment section making it possible, on the one hand, to at least partly separate out the impurities and to purify the solvent to obtain a purified extraction solvent, and on the other hand to recycle at least a portion of the purified extraction solvent to the inlet of the extraction sub-step b3), and/or to the inlet of the dissolution step a) in the case where the dissolution solvent and the extraction solvent are identical. The used solvent may be treated according to any method known to those skilled in the art, for instance one or more methods from among the following: distillation, evaporation, extraction, adsorption, crystallization and precipitation of insoluble matter, or by purging.

### Adsorption Sub-Step b4)

Step b) of the treatment process according to the invention may comprise an adsorption sub-step b4), for obtaining at least one refined polymer solution. The refined polymer solution obtained at the end of sub-step b4) advantageously comprises the polypropylene which the present invention seeks to recover purified, dissolved in the dissolution solvent.

When it is incorporated into the process according to the invention, the adsorption sub-step b4) is advantageously performed downstream of the dissolution step a) and upstream of the polymer-solvent separation step c). It may be performed upstream of a sub-step b1) of separating out the insoluble matter and/or a washing sub-step b2) and may correspond in particular to the optional intermediate adsorption step a′). Preferably, it is performed downstream of a sub-step b1) of separating out the insoluble matter and possibly of a washing sub-step b2), which is itself preferably downstream of sub-step b1). It may also be performed, for example, upstream or downstream of an extraction sub-step b3). Thus, the adsorption sub-step b4) is performed by placing the polymer solution which feeds it, in particular the crude polymer solution obtained from step a), the clarified polymer solution obtained from b1) or the washed polymer solution obtained from b2) or else the extracted polymer solution obtained from b3), in contact with one or more adsorbents.

The adsorption sub-step b4) advantageously includes an adsorption section operated in the presence of at least one adsorbent, which is preferably solid, and in particular in the form of a fixed bed, an entrained bed (or slurry, i.e. in the form of particles introduced into the stream to be purified and entrained with this stream) or in the form of an ebullated bed, preferably in the form of a fixed bed or an entrained bed. Each adsorbent(s) used in sub-step b4) is preferably an alumina, a silica, a silica-alumina, an active charcoal, a bleaching earth, or mixtures thereof, preferably an active charcoal, a bleaching earth or mixtures thereof, preferably in the form of a fixed bed or an entrained bed, the circulation of the streams possibly being ascending or descending.

Advantageously, when it is incorporated into the process, the adsorption sub-step b4) is performed at a temperature preferably between 150° C. and 250° C., preferentially between 160° C. and 225° C., very preferentially between 165° C. and 210° C. and preferably between 170° C. and 195° C., and at a pressure of between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute. Very advantageously, the adsorption sub-step b4) is performed under the dissolution temperature and pressure conditions, i.e. at the dissolution temperature and dissolution pressure of step a). Preferably, in the optional sub-step b4), the hourly space velocity (or HSV), which corresponds to the ratio between the volume flow rate of the polymer solution which feeds b4) and the volume of adsorbent, advantageously operating in b4), is between 0.05 and 10 h⁻¹, preferentially between 0.1 and 5.0 h⁻¹.

According to a particular embodiment of sub-step b4), the adsorption section may comprise one or more fixed beds of one or more adsorbents, for example in the form of adsorption columns, preferably at least two adsorption columns, preferentially between two and four adsorption columns, containing said adsorbent(s). When the adsorption section comprises two adsorption columns, one operating mode may be that referred to as “swing” operating according to the dedicated terminology, in which one of the columns is on-line, i.e. in service, while the other column is in reserve. When the adsorbent of the on-line column is spent, this column is isolated, while the column in reserve is brought on-line, i.e. in service. The spent adsorbent can then be regenerated in situ and/or replaced with fresh adsorbent so that the column containing it can once again be brought on-line once the other column has been isolated.

Another mode of functioning of this particular embodiment of b4), comprising one or more fixed beds of one or more adsorbents, is to have at least two columns functioning in series. When the adsorbent of the column placed at the head is spent, this first column is isolated and the spent adsorbent is either regenerated in situ or replaced with fresh adsorbent. The column is subsequently brought back on-line in the last position, and so on. This operation is known as permutable mode, or according to the term PRS for Permutable Reactor System, or also “lead and lag”. The combination of at least two adsorption columns makes it possible to overcome the possible and potentially rapid poisoning and/or clogging of the adsorbent due to the combined action of the impurities, of the contaminants and of the insoluble matter that may be present in the stream to be treated. The reason for this is that the presence of at least two adsorption columns facilitates the replacement and/or regeneration of the adsorbent, advantageously without stoppage of the process, also making it possible to control the costs and to limit the consumption of adsorbent.

According to this particular embodiment of sub-step b4) of adsorption in a fixed bed of one or more adsorbents, sub-step b4) is preferably performed downstream of a sub-step b1) of separating out the insoluble matter and/or of a washing sub-step b2), and optionally upstream or downstream of an extraction sub-step b3). Advantageously, the combination of a sub-step b1) of separating out the insoluble matter, and/or of a washing sub-step b2), and optionally of an extraction sub-step b3), with an adsorption sub-step b4) allows improved purification of the polymer solution, by using the affinity of the residual impurities both for the adsorbent and for the extraction solvent and optionally a dense solution.

The adsorption section of b4) may, according to another embodiment, consist in adding adsorbent particles to the polymer solution, in particular the crude polymer solution, said particles possibly being separated from the polymer solution via a step of removing the adsorbent particles located downstream of said adsorption section. The removal of the adsorbent particles may then advantageously correspond to a sub-step b1) of separating out the insoluble matter or to a washing sub-step b2). Such an implementation of the adsorption sub-step b4), by introducing the adsorbent particles followed by solid/liquid separation, advantageously corresponds to the optional intermediate adsorption step a′), described earlier in the present description.

### Step c) of Solvent-Polymer Separation

According to the invention, the process comprises a solvent-polymer separation step c), to obtain at least one purified polypropylene fraction and preferably a solvent fraction.

The solvent-polymer separation step c) advantageously includes at least one supercritical separation section, followed by at least one solvent recovery section, preferably between one and five solvent recovery section(s), in series. The solvent-polymer separation step c), more particularly the supercritical separation section, in particular the first supercritical separation section, is fed with the purified polymer solution obtained from the purification step b).

The solvent-polymer separation step c) is thus first directed towards at least partly, preferably predominantly or even totally, separating out the solvent(s), in particular the dissolution solvent, contained in the purified polymer solution which feeds step c), so as to recover the polypropylene which has been at least partly, preferably predominantly and preferentially totally freed of the impurities and of the dissolution solvent and possibly of the other solvent(s) used in the process (i.e. the extraction solvent and/or the dense solution). The term “predominantly” should be understood as meaning at least 50% by weight, preferentially preferably at least 70% by weight, preferably at least 90% by weight, very preferably at least 95%, relative to the weight of the solvent(s) contained in the purified polymer solution which feeds step c), in particular of the dissolution solvent and optionally of the extraction solvent and/or the dense solution contained in the purified polymer solution which feeds step c). Any method for separating the solvent from the polymers which is known to those skilled in the art may be performed, in particular any method enabling a phase change of the polymers or of the solvent(s). The solvent(s) may be separated out, for example, by evaporation, stripping, demixing, a difference in density and in particular decantation or centrifugation, etc.

The fraction of purified polypropylene obtained at the end of step c) may correspond to a concentrated polypropylene solution or to liquid (i.e. molten) or solid purified polypropylene. The solvent-polymer separation step c) may optionally also comprise a conditioning section for conditioning the recovered purified polypropylene, in solid form and more particularly in the form of solid granules. In this possible conditioning section, the recovered purified polypropylene is cooled, advantageously to a temperature below the melting point of the polypropylene, to obtain a fraction including polypropylene in solid form.

The solvent-polymer separation step c) is also directed towards at least partly, preferably predominantly and preferentially totally recovering the solvent(s) contained in the purified polymer solution which feeds step c), and in particular the dissolution solvent and optionally the extraction solvent and/or the dense solution. The term “predominantly” should be understood as meaning at least 50% by weight, preferentially preferably at least 70% by weight, preferably at least 90% by weight, very preferably at least 95%, relative to the weight of the solvent(s) contained in the purified polymer solution which feeds step c). Thus, step c) advantageously also makes it possible to obtain at least one solvent fraction. The solvent-polymer separation step c) is also optionally directed towards purifying the recovered solvent fraction and recycling it, in particular upstream of the dissolution step a) and possibly upstream of sub-step b2) and/or of sub-step b3).

The solvent-polymer separation step c) thus includes a supercritical separation section which makes it possible to at least partly separate out dissolution solvent, and possibly the extraction solvent and the dense solution, and optionally some of the residual impurities which would not have been eliminated during step b), under temperature and pressure conditions adjusted so as to be under supercritical conditions, i.e. beyond the critical point of the solvent(s) to be separated out, in particular beyond the critical point of the dissolution solvent, more particularly beyond the critical point of the predominant hydrocarbon-based compound of the dissolution solvent, which advantageously makes it possible to easily separate out and recover at least a portion of the solvent, in particular of the dissolution solvent. This supercritical separation section in particular includes a system of fluids which is composed of a supercritical phase predominantly comprising solvent, in particular dissolution solvent, and of a liquid phase comprising the polypropylene. The term “predominantly” means herein at least 50% by weight, preferably at least 70% by weight, preferably at least 90% by weight, very preferably at least 95% by weight, relative to the weight of the stream under consideration, i.e. of the supercritical phase. The separation may then be referred to as supercritical separation of the solvent(s). Supercritical separation of the solvent(s) makes it possible to efficiently separate, on the one hand, at least a portion of the solvent(s) and in particular the dissolution solvent, and, on the other hand, the polypropylene or a concentrated polypropylene solution, the supercritical separation advantageously being permitted by the significant difference in density between the two phases, the supercritical phase predominantly comprising solvent, in particular dissolution solvent, and the liquid phase comprising the polypropylene. Furthermore, supercritical separation of the solvent(s) advantageously enables a significantly reduced energy and environmental cost relative to simple vaporization of the solvent, since, during passage to the supercritical state, there is no latent heat of vaporization. The supercritical separation section is advantageously operated at a temperature of between 160° C. and 300° C., preferentially between 190 and 250° C., preferably between 200° C. and 230° C., and at a pressure (Psupercritical) of between 2.7 and 10.0 MPa absolute, preferably between 3.0 and 6.0 MPa absolute, preferentially between 3.0 and 5.0 MPa absolute and preferably between 3.0 and 4.0 MPa absolute.

According to a particular embodiment, the supercritical separation section of step c) is implemented at a pressure (Psupercritical) between the critical pressure of the predominant hydrocarbon-based compound of the dissolution solvent (CP (dissolution solvent)) and a pressure equal to 3.0 MPa above the critical pressure of the predominant hydrocarbon-based compound of the dissolution solvent (i.e.: CP (dissolution solvent)+3.0 MPa), preferentially between the critical pressure of the predominant hydrocarbon-based compound of the dissolution solvent (CP (dissolution solvent)) and a pressure equal to 1.5 MPa above the critical pressure of the predominant hydrocarbon-based compound of the dissolution solvent (i.e.: CP (dissolution solvent)+1.5 MPa), preferably between the critical pressure of the predominant hydrocarbon-based compound of the dissolution solvent (CP (solvent)) and a pressure equal to 0.5 MPa beyond the critical pressure of the predominant hydrocarbon-based compound of the dissolution solvent (i.e.: equal to CP (dissolution solvent)+0.5 MPa), the pressures being absolute pressures, the predominant hydrocarbon-based compound of the dissolution solvent being an advantageously aliphatic, preferably paraffinic, hydrocarbon-based compound with a boiling point of between −15 and 100° C., preferably between 8 and 100° C., preferentially between 25 and 69° C., very preferentially between 25 and 61° C. and preferably between 25 and 40° C., and preferably containing between 4 and 7 carbon atoms, preferably 5, 6 or 7 carbon atoms, preferentially containing 5 or 6 carbon atoms and very preferentially containing 5 carbon atoms, as described in detail in the description of step a) above.

The supercritical separation section of step c) is preferably implemented by demixing and then decanting the liquid phase (comprising the polypropylene) and the supercritical phase (composed of solvent). Advantageously, the supercritical phase from the supercritical separation section at least partly constitutes the solvent fraction obtained at the end of step c). The liquid phase which comprises the polypropylene is preferably sent to a solvent recovery section or a series of solvent recovery sections.

Step c) may optionally comprise one or more successive supercritical separation sections, in particular between one and five, more particularly one, two or three. The liquid phase which comprises polypropylene and which is obtained from a supercritical separation section may thus also be fed into another subsequent supercritical separation section, the liquid phase from the last supercritical separation section advantageously being sent to a solvent recovery section or a series of solvent recovery sections. Very preferably, step c) comprises one supercritical separation section.

Very advantageously, the supercritical separation of the solvent makes it possible to reduce the content of residual impurities of the purified polypropylene fraction even further.

Preferably, the supercritical section, optionally the series of supercritical separation sections, is followed by at least one, preferably between one and five, preferably successive solvent recovery sections. The first solvent recovery section is fed with the liquid phase comprising polypropylene and obtained from the supercritical separation section, optionally the series of supercritical separation sections and in particular from the last supercritical separation section, and, in the case where the separation section comprises at least two solvent recovery sections, each of the subsequent solvent recovery sections, i.e. from the second solvent recovery section onwards, is fed with the liquid phase comprising polypropylene and obtained from the preceding solvent recovery section, for example the second solvent recovery section being fed by the liquid phase comprising the targeted thermoplastic polymers obtained from the first solvent recovery section. The liquid phase containing polypropylene, obtained from the last solvent recovery section, constitutes the purified polypropylene fraction obtained at the end of step c).

The phase or combination of phases containing only solvent obtained from the solvent recovery sections constitutes, together with the supercritical phase obtained from the supercritical separation section, optionally from the series of supercritical separation sections, the solvent fraction(s) advantageously recovered at the end of step c). The phase or combination of phases containing only solvent obtained from the solvent recovery sections are preferably in gaseous form and can be condensed and optionally mixed with the supercritical phase obtained from the supercritical separation section, the temperature and pressure conditions of which have advantageously been adjusted beforehand so as to be in liquid form.

Each solvent recovery section is implemented at a temperature advantageously between 160 and 300° C. (and preferably at a temperature above the melting point of the polypropylene) and a pressure between the pressure used in the supercritical separation section(s) (Psupercritical) and 0.000005 MPa (i.e. 5 Pa). Preferably, each solvent recovery section is implemented at a temperature of between 160 and 300° C. and at a pressure between the pressure of the preceding section of step c) and 0.000005 MPa. Thus, when step c) includes a supercritical separation section and several (at least two) solvent recovery sections, the first solvent recovery section S1, which directly follows the supercritical separation section, is implemented at a pressure P(S1) between the pressure (Psupercritical) used in the supercritical separation section (advantageously directly prior) and 0.000005 MPa; the second solvent recovery section S2, which directly follows the solvent recovery section S1, is implemented at a pressure P(S2) between the pressure P(S1) used in the first solvent recovery section S1 and 0.000005 MPa, and so on for the following sections. According to a preferred embodiment, each solvent recovery section is implemented at a temperature advantageously between 160 and 300° C. and a pressure between the pressure of the preceding section of step c) and 0.000005 MPa and preferably at a pressure between 10.0 MPa and 0.000005 MPa, preferentially between 5.0 MPa and 0.000005 MPa, preferably between 2.7 MPa and 0.000005 MPa. Preferably, the temperature and pressure conditions are adjusted in each solvent recovery section to modify the volatility of the solvent(s) still present in the polymer phase which is advantageously in the form of a concentrated polypropylene solution or in the form of molten or solid polypropylene.

In the case where several different solvents were used in the purification process according to the invention, in particular in the dissolution step a) and optionally in an extraction sub-step b3), step c) may include several solvent recovery sections, for example two, three or four solvent recovery sections, so as to separately, sequentially and/or successively recover the various solvents, in particular the dissolution solvent and optionally the extraction solvent.

Advantageously, the supercritical separation and solvent recovery sections of step c) may be implemented continuously, in batch mode or in fed-batch mode.

Very advantageously, the solvent fraction recovered at the end of step c) may be treated in an organic treatment section located at the end of step c), so as to purify it and to obtain at least one purified solvent, in particular at least one purified dissolution solvent, in order advantageously to be able to recycle it into the dissolution step a) and optionally into the washing sub-step b2) or the extraction sub-step b3). Said optional organic treatment section at the end of step c) may use any method known to those skilled in the art, for instance one or more methods from among distillation, evaporation, liquid-liquid extraction, adsorption, crystallization and precipitation of insoluble matter, or by purging.

The process according to the invention thus makes it possible to obtain a purified stream of polypropylene from plastic waste, which may be used in any application, for example in replacement for virgin resins. The purified stream of polypropylene, i.e. the purified polypropylene fraction, obtained via the process according to the invention thus has contents of impurities and of residual solvent that are low enough to be able to be used in any application. Preferably, the stream of purified polypropylene obtained at the end of the process according to the invention advantageously comprises less than 5% by weight of impurities, very advantageously less than 1% by weight of impurities and very advantageously less than 5% by weight of residual solvent (in particular dissolution solvent), preferably less than 1% by weight of residual solvent, preferably less than 0.1% by weight of residual solvent.

According to a preferred embodiment of the invention, the process for purifying the plastic feedstock, which comprises polypropylene, comprises, and preferably consists of:
a) a step of dissolution in a dissolution solvent comprising at least one aliphatic, paraffinic hydrocarbon-based compound with a boiling point of between −15 and 100° C., preferably between 8 and 100° C., preferentially between 25 and 69° C., very preferentially between 25 and 61° C. and preferably between 25 and 40° C., performed at a dissolution temperature of between 150° C. and 250° C., preferentially between 160 and 225° C., very preferentially between 165° C. and 210° C., and preferably between 170° C. and 195° C., and a dissolution pressure of between 1.0 and 18.0 MPa absolute, preferably between 1.0 and 12.0 MPa absolute, preferentially between 3.0 and 11.0 MPa absolute, preferably between 5.0 and 11.0 MPa absolute and very preferably between 6.0 and 10.0 MPa absolute, to obtain at least one crude polymer solution; and then
b) a step of purifying the polymer solution, comprising:
   b1) a sub-step of separating out the insoluble matter to obtain a clarified polymer solution and an insoluble fraction; and then
   b4) a sub-step of adsorption of the impurities by contact of the clarified polymer solution with an adsorbent, to obtain at least one refined polymer solution; and then
c) a solvent-polymer separation step using at least one supercritical separation section operated at a temperature between 160 and 300° C., preferably between 190 and 250° C., preferentially between 200 and 230° C., and at a pressure (Psupercritical) of between 2.7 and 10.0 MPa abs., preferably between 3.0 and 6.0 MPa abs., preferentially between 3.0 and 5.0 MPa abs. and preferably between 3.0 and 4.0 MPa abs., followed by at least one solvent recovery section, operated at a temperature of between 160 and 300° C. and a pressure between the pressure of the supercritical separation section (Psupercritical) and 0.000005 MPa (i.e. 5 Pa), in order to obtain at least one fraction of purified polypropylene.

According to another aspect, the present invention relates to a device for purifying a plastic feedstock, which comprises polypropylene, said device comprising, preferably consisting of:
a) a section for dissolving the plastic feedstock in a dissolution solvent advantageously comprising at least one paraffinic aliphatic hydrocarbon-based compound, performed at a dissolution temperature of between 150 and 250° C., preferentially between 160 and 225° C., very preferentially between 165 and 210° C. and preferably between 170 and 195° C., and at a dissolution pressure of between 1.0 and 18.0 MPa absolute, preferably between 1.0 and 12.0 MPa absolute, preferably between 3.0 and 11.0 MPa absolute, preferably between 5.0 and 11.0 MPa absolute, very preferably between 6.0 and 10.0 MPa absolute, to obtain at least one crude polymer solution; and then
b) a section for purifying the crude polymer solution, comprising:
   b1) an insoluble matter separation sub-section; and/or
   b2) a washing sub-section, by contact with a dense solution; and/or
   b3) an extraction sub-section, by contact with an extraction solvent; and/or
   b4) an impurity adsorption sub-section by contact with an adsorbent; and then
c) a solvent-polymer separation section comprising at least one supercritical separation section operated at a temperature of between 160 and 300° C., preferably between 190 and 250° C., preferentially between 200 and 230° C., and at a pressure (Psupercritical) of between 2.7 and 10.0 MPa abs., preferably between 3.0 and 6.0 MPa abs., preferably between 3.0 and 5.0 MPa abs. and preferably between 3.0 and 4.0 MPa abs. followed by at least one solvent recovery section, operated at a temperature between 160 and 300° C. and a pressure between the pressure of the supercritical separation section (Psupercritical) and 0.000005 Mpa (i.e. 5 Pa), in order to obtain at least one purified polypropylene fraction.

Preferably, the purification section b) comprises:
b1) an insoluble matter separation sub-section to obtain a clarified polymer solution and an insoluble fraction; then
b4) a sub-section for adsorption of impurities by bringing the clarified polymer solution into contact with an adsorbent, to obtain at least one refined polymer solution.

The examples that follow illustrate the invention, in particular particular embodiments of the invention, without limiting the scope thereof.

### EXAMPLES

### Example 1 (In Accordance with the Invention)

### Dissolution Step a):

A feedstock obtained from plastic waste and containing 95% by weight of polypropylene (PP) is fed in flake form into an extruder heated to 180° C. On leaving the extruder, the feedstock is at least partly in molten form and is mixed with a solvent comprising 99% n-pentane and previously heated to 180° C., at a solvent/feedstock mass ratio of 9:1. The mixture of solvent and feedstock is introduced into a stirred reactor and heated to 180° C., and maintained at 7 MPa absolute, for a residence time of 1 hour. A polymer solution is then obtained.

The polymer solution from the dissolution step a) is then subjected to a purification step b):

The polymer solution is continuously withdrawn from the stirred reactor and passed through three filters placed in series, maintained at 180° C. and having cut-off diameters of 500 μm, 100 μm and 10 μm respectively (in that order). The pressure drop across the filters is 0.05 MPa.

At the outlet of the series of filters, the clarified polymer solution passes through an adsorption section comprising a bed of activated charcoal particles with a contact time of 2 hours and then a filter to retain the activated charcoal particles. This adsorption section is operated at 180° C. It leads to a pressure drop of 0.2 MPa.

The purified polymer solution from purification step b) is then subjected to a solvent-polymer separation step c) comprising a supercritical section:

The purified polymer solution from the adsorption section is then heated to 210° C., the pressure being slightly less than 7 MPa (dissolution pressure minus the pressure drops induced in the sections of purification step b)). The polymer solution is then expanded to 4 MPa absolute and injected into a decanter maintained at 4 MPa abs and 210° C. and for a residence time of 5 minutes. Two phases are formed: an upper phase predominantly comprising n-pentane solvent in the supercritical state and a lower liquid phase comprising polypropylene dissolved in n-pentane solvent. The upper phase is drawn off from the upper part of the decanter.

The lower liquid phase is then subjected to evaporation of the residual solvent, in two successive evaporation sections: firstly at a temperature of 210° C. and a pressure of 0.5 MPa for 5 minutes, and secondly at a temperature of 210° C. and a pressure of 0.01 MPa for 2 minutes.

At the end of the process, at atmospheric temperature and pressure, a solid A composed of purified polypropylene (PP) is obtained. Solid A is analysed.

The solid A obtained is almost colourless and almost translucent and comprises less than 5% by weight of impurities and less than 1% by weight of n-pentane.

### Example 2 (Non-Compliant)

In this example 2, the same feedstock is processed and steps a) of dissolution and b) of purification are conducted in the same manner as the process described in Example 1.

The purified polymer solution from purification step b) is subjected to a solvent-polymer separation step not including a supercritical section:

The purified polymer solution from the adsorption section is maintained at 180° C. and expanded to 2 MPa absolute and then injected into a decanter maintained at 2 MPa abs and 180° C., for a residence time of 5 minutes. Two phases are formed: a gaseous upper phase composed of n-pentane solvent and a liquid lower phase comprising polypropylene dissolved in n-pentane solvent. The gas phase is drawn off from the upper part of the decanter.

The lower liquid phase is then subjected to evaporation of the residual solvent, initially at a temperature of 210° C. and a pressure of 0.5 MPa for 5 minutes and then at a temperature of 210° C. and a pressure of 0.01 MPa for 2 minutes.

At the end of the process, at atmospheric temperature and pressure, a solid B composed of purified polypropylene (PP) is obtained. Solid B is analysed.

The solid B obtained is almost colourless and almost translucent and comprises less than 5% by weight of impurities and less than 1% by weight of n-pentane.

5 However, the content of impurities (organic compounds excluding the dissolution solvent) in solid B is higher than that measured in solid A obtained in Example 1 in accordance with the invention.

Furthermore, according to Example 2, the energy consumption required for the polymer-solvent separation is greater than the energy consumption required for the polymer-solvent separation of the process described in Example 1, i.e. when the polymer-solvent separation comprises a supercritical phase section.

1. A process for purifying a plastic feedstock which comprises polypropylene. said process comprising:
a) a dissolution step involving placing the plastic feedstock in contact with a dissolution solvent, comprising at least one hydrocarbon-based compound having a boiling point of between −15 and 100° C. at a dissolution temperature of between 150° C. and 250° C. and a dissolution pressure of between 1.0 and 18.0 MPa absolute, to obtain at least one crude polymer solution;
b) a step of purifying the crude polymer solution to obtain a purified polymer solution, comprising:
b1) a sub-step of separating out the insoluble matter; and/or
b2) a sub-step of washing, by contact with a dense solution; and/or
b3) a sub-step of extraction, by contact with an extraction solvent; and/or
b4) a sub-step of adsorption of the impurities by contact with an adsorbent; and then
c) a solvent-polymer separation step. using at least one supercritical separation section operated at a temperature of between 160 and 300° C. and at a pressure (Psupercritical) of between 2.7 and 10.0 MPa absolute, followed by at least one solvent recovery section. to obtain at least one purified polypropylene fraction.

2. The process according to claim 1, wherein the plastic feedstock comprises at least 80% by weight, preferably at least 85% by weight, preferably at least 90% by weight of polypropylene relative to the total weight of the plastic feedstock.

3. The process according to claim 1, wherein the dissolution solvent comprises an aliphatic hydrocarbon-based compound with a boiling point of between 8° C. and 100° C. preferably between 25° C. and 69° C. preferentially between 25° C. and 61° C. and preferably between 25° C. and 40° C.

4. The process according to claim 1, wherein the dissolution step a) is performed at a dissolution temperature of between 160° C. and 225° C. preferentially between 165° C. and 210° C. and preferably between 170° C. and 195° C.

5. The process according to claim 1, wherein the dissolution step a) is performed at a dissolution pressure of between 1.0 and 12.0 MPa absolute, preferably between 3.0 and 11.0 MPa absolute, preferentially between 5.0 and 11.0 MPa absolute and preferably between 6.0 and 10.0 MPa absolute.

6. The process according to claim 1, wherein the purification step b) comprises at least the sub-step b1) of separating out insoluble matter, optionally followed by a sub-step b2) of washing by contact with a dense solution, and/or a sub-step b3) of extraction by contact with an extraction solvent. and/or a sub-step b4) of adsorption of the impurities by contact with an adsorbent.

7. The process according to claim 1, wherein the supercritical separation section in step c) is operated at a temperature of between 190 and 250° C. preferentially between 200 and 230° C.

8. The process according to claim 1, wherein the supercritical separation section in step c) is operated at a pressure (Psupercritical) of between 3.0 and 6.0 MPa absolute, preferentially between 3.0 and 5.0 MPa absolute and preferably between 3.0 and 4.0 MPa absolute.

9. The process according to claim 1, wherein step c) comprises between one and five solvent recovery sections, each solvent recovery section being operated at a temperature of between 160 and 300° C. and a pressure between the pressure of the supercritical separation section (Psupercritical) and 0.000005 MPa. preferentially between 2.7 MPa and 0.000005 MPa.

10. A device for purifying a plastic feedstock, which comprises polypropylene, said device comprising:
a) a section for dissolving the plastic feedstock in a dissolution solvent, operated at a dissolving temperature of between 150 and 250° C., and at a dissolution pressure of between 1.0 and 18.0 MPa absolute, to obtain at least one crude polymer solution; and then
b) a section for purifying the crude polymer solution, comprising:
b1) an insoluble matter separation sub-section; and/or
b2) a washing sub-section, by contact with a dense solution; and/or
b3) an extraction sub-section, by contact with an extraction solvent; and/or
b4) an impurity adsorption sub-section by contact with an adsorbent; and then
c) a solvent-polymer separation section comprising at least one supercritical separation section operated at a temperature of between 160 and 300° C. and at a pressure Psupercritical of between 2.7 and 10.0 MPa absolute, followed by at least one solvent recovery section, operated at a temperature of between 160 and 300° C. and a pressure between the pressure of the supercritical separation section Psupercritical and 0.000005 MPa (i.e. 5 Pa), to obtain at least one purified polypropylene fraction.

11. The process according to claim 1, wherein the plastic feedstock comprises at least 85% by weight of polypropylene relative to the total weight of the plastic feedstock.

12. The process according to claim 1, wherein the dissolution solvent comprises an aliphatic hydrocarbon-based compound with a boiling point of between 25° C. and 69° C.

13. The process according to claim 1, wherein the dissolution step a) is performed at a dissolution temperature of between 165° C. and 210° C.

14. The process according to claim 1, wherein the dissolution step a) is performed at a dissolution pressure of between 3.0 and 11.0 MPa absolute.

15. The process according to claim 1, wherein the supercritical separation section in step c) is operated at a temperature of between 200 and 230° C.

16. The process according to claim 1, wherein the supercritical separation section in step c) is operated at a pressure (Psupercritical) of between 3.0 and 5.0 MPa absolute.

17. The process according to claim 1, wherein step c) comprises between one and five solvent recovery sections, each solvent recovery section being operated at a temperature of between 160 and 300° C. and a pressure between 2.7 MPa and 0.000005 MPa.
